(19) United States
(12) Patent Application Publication
(10) Pub. No.: US 2016/0023795 A1
(43) Pub. Date: Jan. 28, 2016

(54) Combination Drink Bottle and Frozen Comestible Maker

(71) Applicant: Eran Itzhaki, Valley Village, CA (US)

(72) Inventor: Eran Itzhaki, Valley Village, CA (US)

(21) Appl. No.: 14/341,593

(22) Filed: Jul. 25, 2014

(51) Int. Cl. B65D 1/02; B65D 51/18; A23G 9/26

(52) U.S. Cl. CPC B65D 1/02; A23G 9/26; B65D 51/18; B65D 2501/0063

(57) ABSTRACT

An apparatus for enabling consumers to seamlessly convert the contents of a sippable drink container into a handheld frozen comestible. The present invention alleviates the need for consumers to purchase distinct products for when they desire a beverage and when they desire a frozen comestible. Further alleviated is the need for cumbersome and messy homemade kits consisting of plastic molds and popsicle stick support members.

### CROSS-REFERENCE TO RELATED APPLICATIONS

None.

### NOTICE OF COPYRIGHT AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### TECHNICAL FIELD

The present invention relates to apparatuses for making frozen comestible and more specifically an apparatus which is convertible from a juice to popsicle container when thermalized to facilitate healthy consumption by children.

### DISCUSSION OF THE RELATED ART

Children may be reluctant to consume particular food items for a variety of different reasons. The inherent taste may be displeasing, the texture may be undesirable, or the child may prefer an alternative means of ingestion such as licking or chewing over drinking.

Some children find particular amusement in alternative ways of engaging their food. Historically, there has been particular appeal associated with making food products easier to manipulate by introducing a support member. This has inspired many inventions. By way of example, hot dogs typically consumed with buns have led to the more portable “on a stick” embodiment. A similar trend followed with burritos (see U.S. Pat. No. 4,447,457) and pizza (see U.S. Pat. No. 4,966,781) and even friedcake (see U.S. Pat. No. 4,144,356).

One particular and well known product comprises ice cream in a tubular cardboard container with a piston underlying it. The ice cream is selectively advanced out of the tube by pushing a stick attached to the bottom of the piston. A similar comestible apparatus is described in U.S. Pat. No. 3,962,470.

Frozen comestible enjoy wide popularity. Both children and adults experience a fondness for frozen items, such as ice pops, ice cream, and the like. Frequently, such frozen items attract additional customers, particularly younger customers. This has inspired numerous commercially available home-made kits comprising molds and popsicle sticks or holders Using these devices, fruit juice or other edible liquids may be poured in and frozen in a home freezer. Despite the advantages provided by such products, there is much room for improvement with respect to a number of aspects.

Many of the aforementioned kits have proven unmerchantable due to their cumbersome dimensions, very limited functionality and singular use. Accordingly, there exists a need for an apparatus that incorporates the desirous properties of frozen comestibles while overcoming the disadvantages of all the suggestions heretofore known. Such an invention would appeal to both parents and commercial retailers including ice cream vendors and grocery stores. The present invention effectuates these needs.

### SUMMARY

Herein provided is an apparatus for enabling consumers to seamlessly convert the contents of a sippable drink container into a handheld frozen comestible. The present invention alleviates the need for consumers to purchase distinct products for when they desire a beverage and when they desire a frozen comestible. Further alleviated is the need for cumbersome and messy homemade kits consisting of plastic molds and popsicle stick support members. These offerings generally comprise multiple, and unusually-shaped, trays for producing a plurality of comestibles. These attributes make them unnecessarily large, cumbersome to store, and difficult to clean.

The present disclosure relates to portable beverage containers which may be either disposable or reusable. The apparatus comprises a beverage compartment that may be comprised of glass, plastic or other materials capable of transporting liquids and will not be damaged when thermalized. Furthermore, the apparatus can be fashioned to be collapsible. By way of example, in one embodiment, the beverage compartment may be collapsable about two or more pivot points facilitating flat storage.

The beverage compartment may further comprise a molding cavity for receiving a fluid to be thermalized. The disclosed apparatus enables use of the same container to store and thermalize a variety of different liquids. By way of example, and not limitation, these may include fruit juices, water, soda, and different mixtures of the same. By using the disclosed apparatus, the consumer has the choice to enjoy the contents of the disclosed apparatus in either liquid or frozen form without any additional molds or sticks. The molding cavity may comprise a coating on an inner surface thereof to facilitate removal of the frozen comestible. The molding cavity may further include one or more heat exchangers on an external surface thereof.

The present invention further comprises a cap assembly with integrated straw and handle for holding frozen contents of the apparatus. The drinking straw may extend through the wall of the cap, downwardly to the bottom of the beverage compartment and upwardly to a position where it is available for the user to drink from. In one embodiment, the cap assembly may comprise a valve for controlling flow of the beverages stored in the container through the cap partition.

A combination spout and hallow core stick assembly is included to facilitate drinking the beverage when the contents of the apparatus are in their liquid state. The same assembly is operable to secure the contents to the handle when thermalized. In one embodiment, this assembly is a rigid member to ensure it remains strait facilitating removal of the thermalized contents from the beverage compartment. Furthermore, the bottom of the cap may act as drip guard extending outwardly from the spout and core stick assembly to prevent the comestible from ending up on the user.

In one embodiment of the present invention, the spout and cap assembly are detachable to facilitate clean up making it easier for users to wash the reusable embodiment. In another embodiment of the apparatus, the spout and cap assembly are permanently connected.

In a particular embodiment of the invention, the beverage compartment comes prefilled. In another embodiment, the apparatus is sold with the beverage compartment empty allowing users the option to select which type of liquid they would like it to be filled with. In one embodiment, the handle may be joined to the upper portion of the cap by an integral hinge joint so as to swing between an open position, in which the spout is exposed at the top for drinking the contents of the beverage container, and a closed position, in which the handle fits tightly on the cap, closing and sealing the otherwise open area thus helping avoid spillage.

The handle of the cap assembly may be ergonomically designed to fit comfortably in either hand of the user. Furthermore, the spout is also designed to fit easily in the mouth of the user allowing ergonomic consumption of the contents when in liquid form.

In one embodiment, a sealing means is used to secure the handle to the rest of the cap assembly thus ensuring the spout and contents of the beverage container are not accidentally exposed to contaminants. Such a sealing means may include, but is not limited to, twist-on cover, peel-off cover, or snap-on cover.

In various embodiments, a method for using the apparatus of the present disclosure includes, securing the handle member over the spout assembly of the apparatus, chilling the entire apparatus in a refrigeration device to a temperature below the freezing point of the liquid contained therein for several hours, removing the container from the refrigeration device, using the handle member to extract the contents of the beverage compartment from the molding chamber thereby producing a frozen comestible that is ready for consumption.

These and other objects, features, and advantages of the present invention will become apparent in the following detailed description of the present embodiment thereof when read in conjunction with the accompanying drawings wherein the same reference numerals denote like or similar parts throughout the several views.

Although the description that follows contains many specificities, these should not be construed as limiting the scope of the embodiments but as merely providing illustrations of some of several embodiments. Thus the scope of the embodiments should be determined by the claims that are appended and their legal equivalents, rather than by the examples given. Those skilled in the art to which this invention pertains will be able to devise other forms thereof within the ambit of the appended claims.

### DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

### FIGURES

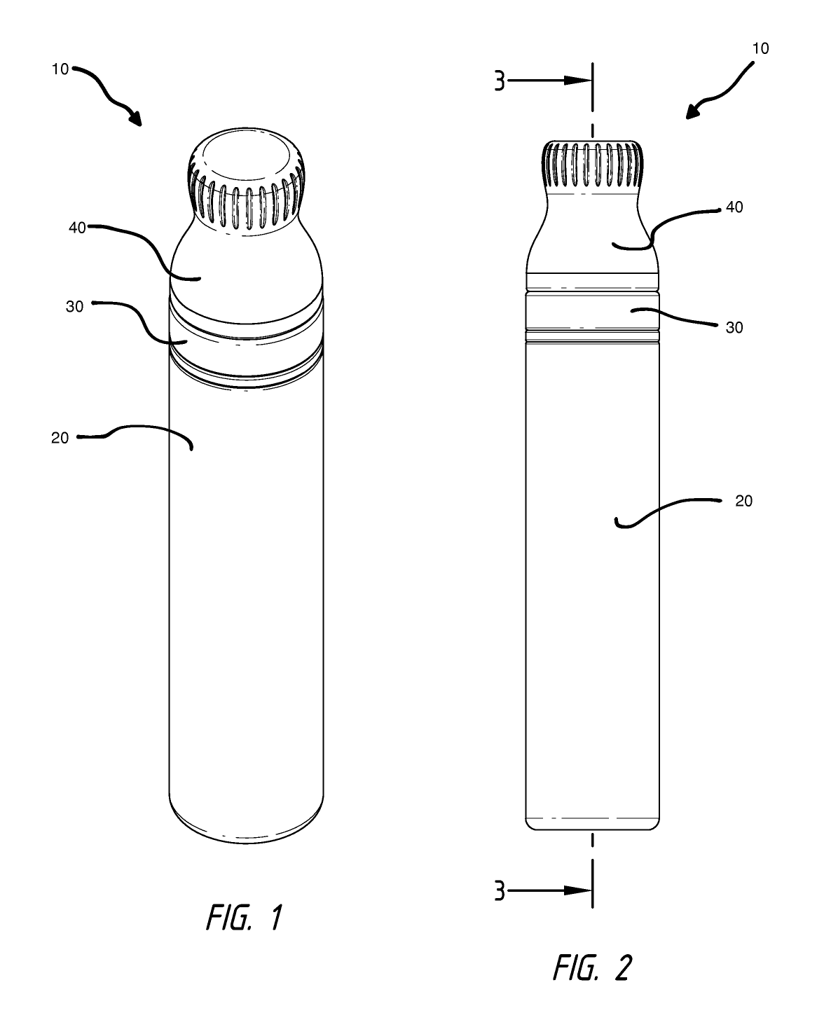

FIG. 1 is a perspective view of an exemplary embodiment of a combination drink bottle and frozen comestible maker according to the present invention;

FIG. 2 is a profile view of the apparatus shown in shown in FIG. 1;

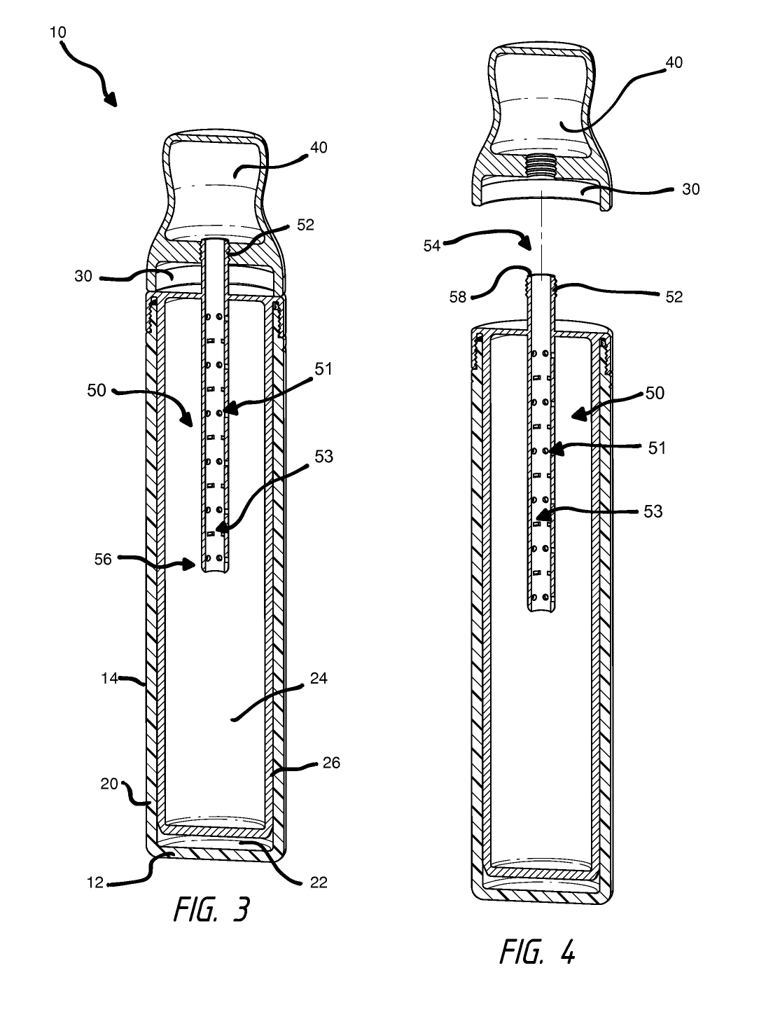

FIG. 3 is a cross-sectional view of the apparatus shown in FIG. 1;

FIG. 4 is a cross-sectional view of the apparatus shown in FIG. 1 with the cap and handle removed;

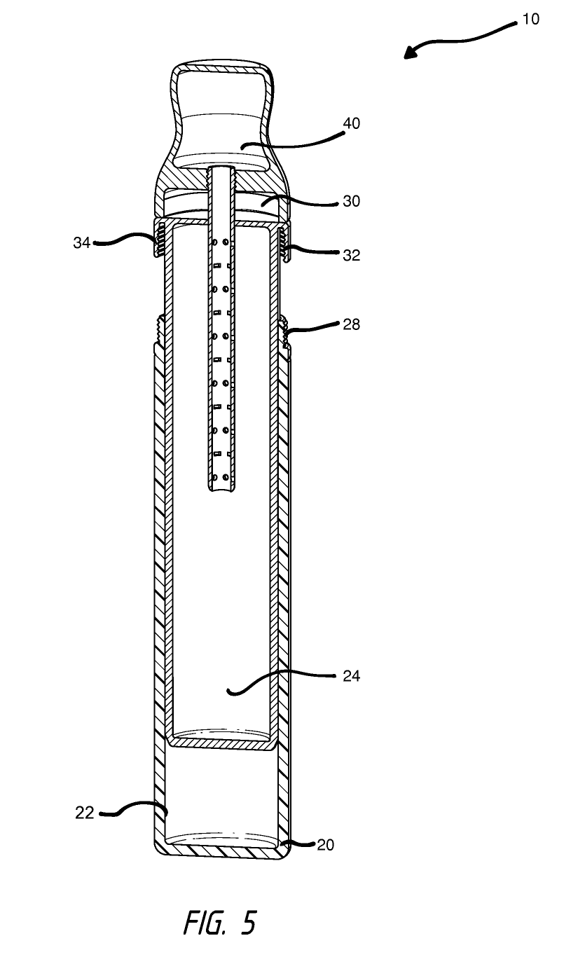

FIG. 5 is a cross-sectional view of the apparatus shown in FIG. 1 after the contents of the beverage compartment have been frozen and the handle, core stick, and cap have been separated from the beverage compartment;

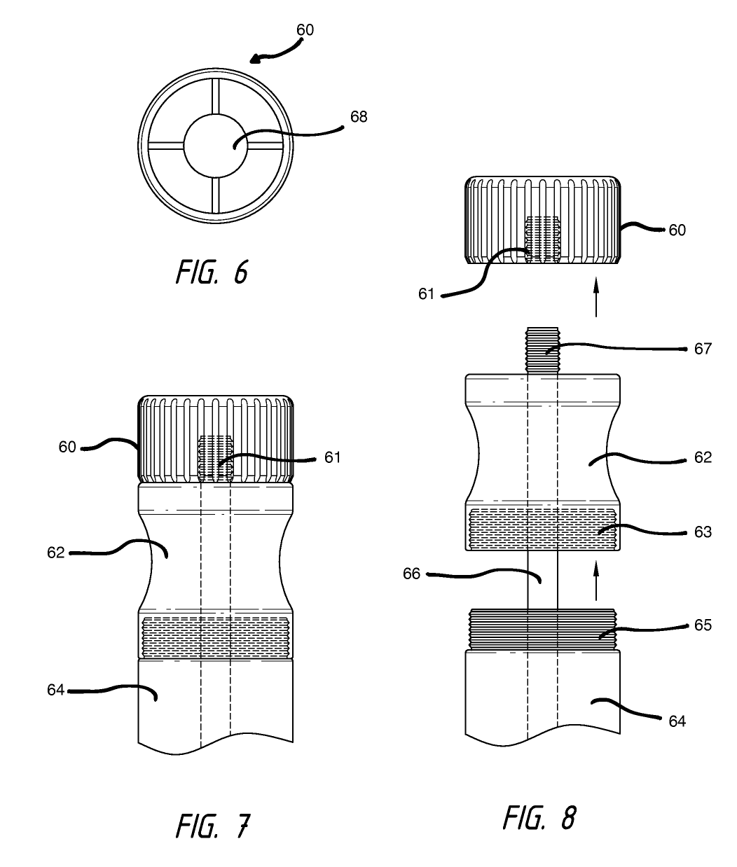

FIG. 6 is a top view of a cap according to one embodiment of the present invention;

FIG. 7 illustrates an exemplary way in which the handle member, cap, core stick, and beverage compartment may engage one another;

FIG. 8 depicts the apparatus of FIG. 7 after all of the different members have been separated from one another;

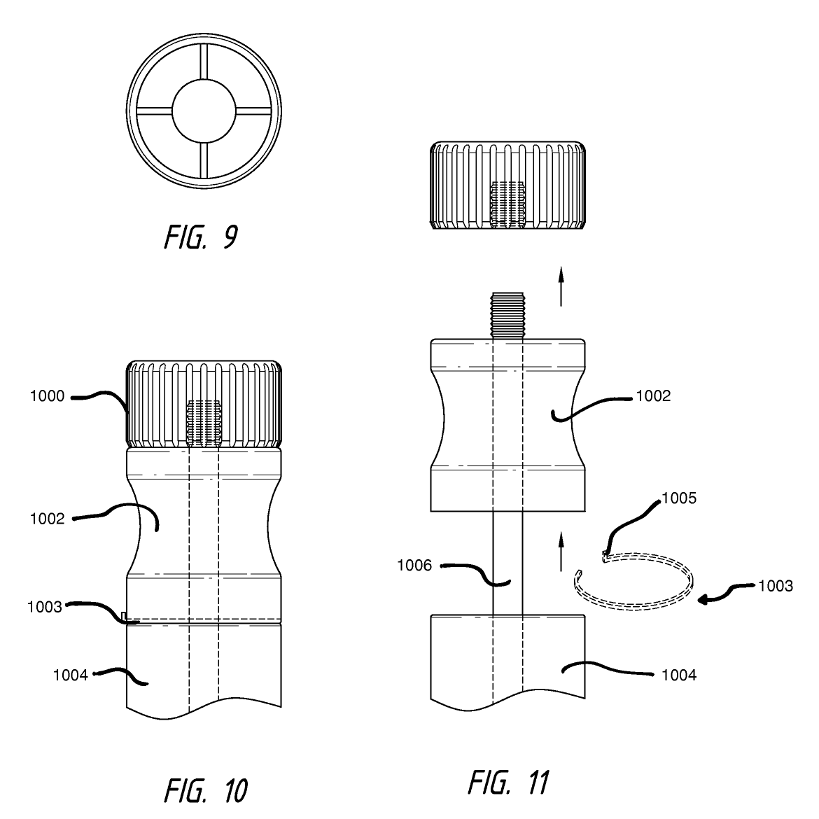

FIG. 9 is a top view of a cap according to one embodiment of the present invention;

FIG. 10 illustrates a second exemplary way in which the handle member, cap, core stick, and beverage compartment may engage one another;

FIG. 11 depicts the apparatus of FIG. 10 after all of the different members have been separated from one another;

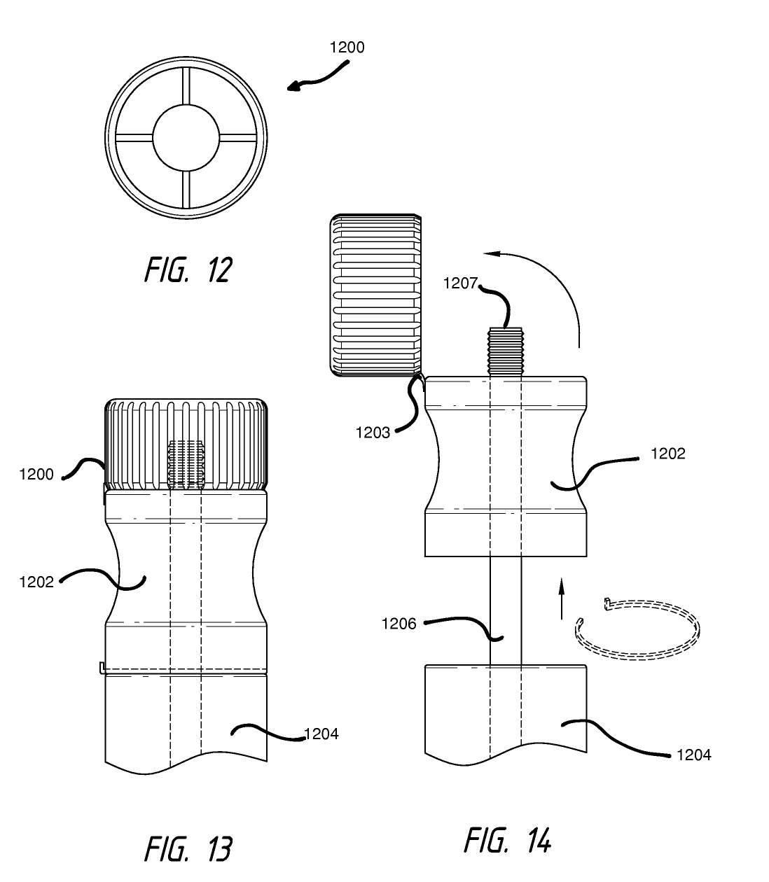

FIG. 12 is a top view of a cap according to one embodiment of the present invention;

FIG. 13 illustrates a third exemplary way in which the handle member, cap, core stick, and beverage compartment may engage one another; and

FIG. 14 depicts the apparatus of FIG. 13 after all of the different members have been separated.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

The disclosed apparatus and methods for seamlessly converting the contents of a sippable drink container into a handheld frozen comestible comprising a beverage compartment, molding cavity, cap assembly, spout, and core stick used for chilling the entire apparatus in a refrigeration device to a temperature below the freezing point of the liquid contained therein. Such an apparatus may be used for quickly freezing puree or juice, for creating ice pops, ice cream pops, yogurt pops, puree pops, fruit pops, POPSICLES, FUDGESICLES, CREAMSICLES or other comestibles, particularly comestibles disposed on a stick. The disclosed apparatus will freeze its contents to a solid or semi solid from the outside in. Any suitable substance that can be poured into such apparatus is frozen and extracted easily for consumption, thereby alleviating the need for separate molds and sticks when a consumer desires converting their beverage into a frozen comestible.

Referring now to FIGS. 1-14, wherein similar components of the present disclosure are referenced in like manner, various exemplary embodiments of a method and apparatus for making frozen comestibles are disclosed. It should be understood that the figures are not drawn to scale and that the invention is not limited to the absolute or relative dimensions depicted therein.

FIGS. 1-2 depict, in perspective view and profile view respectively, an exemplary combination drink bottle and frozen comestible maker 10 according to the present disclosure. The apparatus 10 includes a beverage compartment 20, which serves as a vessel for both drinkable liquids and edible solids. In one embodiment, the beverage compartment 20 may be made of an insulating material, such as a rigid plastic, to protect user's hands from the cold when handling the outside of the compartment 20 and to prevent heat exchange between ambient air and the contents. FIG. 1 further depicts the exterior an exemplary embodiment of the beverage compartment cap 30 and handle member 40.

FIGS. 1-2 also depict an exemplary handle member 40 for use with the apparatus 10. The handle member 40 may be grasped by a human hand while extracting frozen contents from the beverage compartment 20, and also works as a means of holding the frozen comestible making it easier to eat by hand. The handle may comprise a variety of different shapes including, without limitation, popular cartoon or comic book characters, sports team logos, or ergonomic shapes designed to make holding the handle 40 more comfortable.

FIGS. 3-4 depict the apparatus 10 from FIG. 1 and FIG. 2 in cross section. This figure illustrates an exemplary molding cavities 22 of the apparatus 10 closed with all the parts fitted to one another. In FIGS. 3-4, the contents 24 of the cavity 22 are illustrated in the liquid state. The molding cavity 22 is used to dictate the shape of the frozen comestibles produced thereby. In one embodiment of the molding cavity 22, it is made from a material with high thermal conductivity, such as a metal (i.e., a cast aluminum alloy or stainless steel), conductive plastics, and the like, and may be die-cast, injection molded, mechanically stamped, hydro-formed, deep-drawn, or produced by any other suitable process that attains the desired geometry. The shape of an individual molding cavity 22 determines the final shape of the frozen comestible. The possible variations in shape are limitless, i.e. star-shaped, circular, elliptical, racetrack or oval, wavy, diamond, etc.

The core stick 50 is depicted as mated to the handle member 40 in FIG. 3. In this example, the core stick 50 and handle member 40 are connected to one another by threading. The core stick 50 comprises external threads 52 at the top end 54 for engaging the internal threads (not shown) on the inner surface of handle member 40.

This means of connecting the core stick 50 the handle member is submitted by way of example and not limitation. A wide variety of means for connecting the two are envisioned. In one example, the handle member 40 may have tabs (not shown) that apply pressure to the top end 54 when the handle 40 is placed over the core stick 50, this may facilitate quick access to the spout portion 58 of the core stick 50 and does not require any threading on either the stick 50 or the handle 40.

The core stick 50 has a portion that is submerged in the molding cavity 22 to secure the contents of the cavity 22 while frozen. A portion of the core stick 50 is above the comestible and comprises the spout 58 allowing the users to drink the cavity contents 24 when they are in the liquid state.

When the apparatus 10 is closed, the core stick 50 passes through the cap 30 with the rear end 56 inserted into the beverage compartment 20 where is immersed in the fluid contents 24. The molding cavity 22 preferably has a geometry suitable to facilitate centering and balancing the core stick 50 therein and removal of the frozen comestible therefrom.

Furthermore, the core stick 50 is hollow and the portion that is submerged may comprise a plurality of holes 51 or undercut channels 53 to allow liquid to pass through, and after the liquid freezes, it binds securely to the stick 50 both around and from within reducing the chance the frozen comestible will accidentally fall off the stick 50 while being consumed. The length of the submerged portion is, in various embodiments, the same as the depth of the molding cavity 22. This helps to ensures that none of the frozen comestible is left in the molding cavity 22 after extraction.

A minimal friction surface finish of the inside of the molding cavity 22 may facilitate removal of the frozen comestible from the beverage compartment 20. When liquids freeze, they have a tendency to stick to surfaces that they are in contact with. Therefore, a coating may be provided on the inner surface 26 of the molding cavity 22 that minimizes the amount of frozen comestible that sticks to the molding cavity 22. Examples of such a coating may include, but are not limited to anodized aluminum, a special food-grade plastic/epoxy lining (such as used on the interior of aluminum beverage cans), or TEFLON. Any secondary treatment or material that provides a hard, smooth surface finish on the interior of the molding cavity 22, including for example stainless steel, will help ease the manual release of the frozen comestible.

In one embodiment, the beverage compartment 20 comprises a closed bottom 12 and a generally cylindrical side walls 14 which extend upwardly. Furthermore, a fill line (not shown) may be provided to indicate a proper level of fluid to be placed in the beverage compartment 20. The fill line may be a step, an indentation or a printed fill line on the outside of the beverage compartment 20.

FIG. 5 depicts exemplary comestibles produced by refrigerating the apparatus 10 and the contents beyond the freezing temperature of the contents 24. To make frozen comestibles with the apparatus 10 described above, a user would place the apparatus 10 in a freezer or other cooling apparatus until the contents 24 are frozen. Once the contents 24 are frozen, the apparatus 10 may be removed from the freezer and served. The user then disconnects the bottle cap 30 from the beverage compartment 20 to facilitate extraction of the frozen contents 24. This may be done in a number of ways. For the purpose of illustration, in FIG. 5 the cap 30 is removed from the beverage compartment 20 by twisting the two members apart. In this example, the cap 30 and beverage compartment 20 are connected to one another by threading. The beverage compartment 20 comprises external threads 28 at the top end for engaging the internal threads 32 on the inner surface of the cap 30.

When inverted, the cap member 30 may also act as a drip guard as it is disposed between the frozen contents 24 and the user. The outer walls 34 of the cap may be raised with respect to the bottom of the frozen comestible 24. Accordingly, as the comestible begins to melt, the droplets will be caught with the raised walls 34 preventing them from spilling off the sides and onto the hands and clothes of the user or onto the floor.

The outer walls 34 may extends outwardly to create upwardly directed wall. The inner area provides a moat-like structure which collects any liquid melted from the frozen comestible 24 shown in phantom view in FIG. 5. In one embodiment openings (not shown) are provided through the walls 34 to provide a drain for melted comestible into the center of the handle member 40.

In various embodiments, the apparatus 10 may come pre-filled with a variety of different freezable beverages. In other embodiments, the apparatus 10 may be purchased as a stand alone item in which case the user can pour puree, fruit juice, yogurt, or any other freezable liquid comestible into the apparatus 10. The consumer may also combine various pourable contents to create a multi-flavor comestible. Once frozen, the handle 40 and the cap 30 along with the core stick 50 are separated from the beverage compartment 20 creating a frozen treat for the user to enjoy all from an apparatus 10 which may also be used as drink bottle when the contents 24 are liquefied. Once the frozen comestible 24 is consumed, the molding cavity 22 can be refilled with liquid again and the cycle can be repeated over the life of the apparatus 10.

FIGS. 6-14 depict various embodiments for how the beverage compartment, cover, core stick, and handle member may engage one another. These embodiment are proposed by way of example and not limitation. Accordingly, in FIGS. 6-8, the core stick 66 and handle member 60 are connected to one another by threading. The core stick 66 comprises a plurality of external threads 67 at the spout end around where the user would sip the liquid contents of the beverage compartment 64. These threads 67 engage a series of internal threads 61 on the inner surface of handle member 60.

As illustrated in FIG. 6, at least the center portion 68 of the handle member 60 must be covered in order to prevent the contents of the beverage compartment 64 from passing through the core stick 66 and spilling out when the handle member 62 is engaged with the core stick 66 and the apparatus is inverted on or its side.

As shown in FIGS. 7-8 the core stick 66 passes through the cap member 62 and into the beverage compartment 64. The core stick 66 may either be an integral part of the cap member 62 or, in another embodiment, it may be removable to facilitate cleaning the apparatus. In the embodiment illustrated in FIGS. 7-8, the beverage compartment 64 and cap member 62 are connected to one another by threading as well. The cap 62 comprises a plurality of internal threads 63 that engage the external threads 65 of the beverage compartment 64.

FIGS. 9, 10, and 11 depict another embodiment of the apparatus. In this embodiment, the threading that was used to connect the cap 62 and beverage compartment 64 of FIGS. 7 and 8 has been substituted with a tearaway safety seal 1003. As illustrated in FIGS. 10 and 11, the cap member 1002 and the beverage compartment 1004 are connected via a leak proof seal 1003. The seal 1003 remains in tact when the consumer is drinking the contents in the beverage compartment 1004 by sucking through the core stick 1006.

When the consumer freezes the contents of the apparatus, a tab 1005 on one end of the safety seal 1003 may be used to tear it off thereby disconnecting the beverage compartment 1004 from the cap member 1002. Now, the handle member 1000 and the cap 1002 can be used to extract the frozen contents from the beverage compartment 1004.

FIGS. 12-14 further comprise a hinge 1203 as a means for connecting the handle member 1200 to the cap member 1202. In this embodiment, the handle member 1200 is held by a hinge 1203 to cap member 1202. This allows the user to access the spout end 1207 of the core stick 1206 to drink the liquid contents of the beverage compartment 1204. When the user wishes to drink from the spout 1207, the handle 1200 may be hinged outwardly as shown in FIG. 14 of the drawings. When the user is not drinking from the apparatus, they may close the handle 1200 over the spout 1207 to prevent the contents from spilling as shown in FIG. 13.

In this embodiment, the flip top cap handle 1200 is pivotally joined to cap 1202 by the integral hinge 1203. The spout 1207 has a continuous peripheral wall defining a central depression sized to receive the portion of the handle 1200. The interior of the handle comprises a depression formed with a circumferential groove to tightly receive the spout 1207 of the apparatus when the handle is swung from the open condition shown in FIG. 14 to the closed condition shown in FIG. 13 about the opening-closing axis of the hinge 1203. Although the spout 1207 is depicted as threaded in this embodiment, it is further envisioned that, in other embodiments, the spout 1207 will not comprise any threads or added user comfort.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents

### CONCLUSIONS, RAMIFICATIONS, AND SCOPE

While a particular form of the invention has been illustrated and described, it will be apparent that various modifications can be made without departing from the spirit and scope of the invention. For example, the cap member is illustrated in an hourglass shape in some embodiments even though the inventor contemplates the possibility that they may take the shape of popular children characters or athletic team logos all the while comprising the properties of the invention. Accordingly, is not intended that the invention be limited, except as by the appended claims.

The teachings provided herein can be applied to other apparatuses, not necessarily the apparatus described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Particular terminology used when describing certain features or aspects of the invention should not be taken to imply that the terminology is being refined herein to be restricted to any specific characteristics, features, or aspects of the combination drink bottle and frozen comestible maker with which that terminology is associated. In general, the terms used in the following claims should not be constructed to limit the combination drink bottle and frozen comestible maker to the specific embodiments disclosed in the specification, unless the above description section explicitly define such terms. Accordingly, the actual scope encompasses not only the disclosed embodiments, but also all equivalent ways of practicing or implementing the disclosed apparatus. The above description of embodiments of the apparatus is not intended to be exhaustive or limited to the precise form disclosed above or to a particular field of usage. While specific embodiments of, and examples for, the apparatus are described above for illustrative purposes, various equivalent modifications are possible which those skilled in the relevant art will recognize.

While certain aspects of the combination drink bottle and frozen comestible maker are presented below in particular claim forms, the inventors contemplate the various aspects of the apparatus in any number of claim forms. Accordingly, the inventor reserves the right to add additional claims after filing the application to pursue such additional claim forms for other aspects of the combination drink bottle and frozen comestible maker.

What is claimed is:

1. A combination drink bottle and frozen comestible maker apparatus comprising:
a beverage compartment having an upper and an interior portion;
a hollow cylindrical core stick having an upper portion and a lower portion;
a cap member having an upper portion and a lower portion and a hole throughout the center for receiving said core stick;
a handle member having an upper portion and a lower portion and a hole comprised therein for receiving said core stick;
whereby said cap member lower portion can detachably engage with said beverage compartment upper portion;
whereby said cap member upper portion can detachably engage with said handle member lower portion;
whereby said core stick is positioned in said cap member so that when said cap member is engaged with said beverage compartment at least part of said lower portion of said core stick is housed within said interior portion of said beverage compartment; and
at least part of said upper portion of said core stick protrudes from said upper portion of said cap member.

2. The apparatus of claim 1 further comprising a molding cavity for receiving a freezable comestible therein.

3. The apparatus of claim 1 wherein said cap member is shaped to resemble an animated cartoon character.

4. The apparatus of claim 1 wherein said cap member is shaped to resemble a sports team logo.

5. The apparatus of claim 1 wherein said beverage compartment further comprises a fluid fill line.

6. The apparatus of claim 2 wherein said molding cavity includes a coating to facilitate the removal of said comestible when said comestible is frozen.

7. The apparatus of claim 6, wherein said coating is selected from the group consisting of an anodized aluminum, a TEFLON substance, stainless steel, and an epoxy lining.

8. The apparatus of claim 1 wherein said beverage compartment is made from plastic.

9. The apparatus of claim 1 wherein said beverage compartment upper portion comprises a threaded portion having external threads, and said cap member bottom portion comprises a threaded portion having internal threads, said external threads of said threaded portion of said beverage compartment threadedly engages said internal threads of said threaded portion of said cap member bottom portion.

10. The apparatus of claim 1 wherein said cap member upper portion comprises a threaded portion having external threads, and said handle member bottom portion comprises a threaded portion having internal threads, said external threads of said threaded portion of said cap member threadedly engages said internal threads of said threaded portion of said handle member bottom portion.

11. The apparatus of claim 1 wherein said handle member is pivotally joined to said cap member upper portion for swinging relative thereto about an opening-closing axis said handle member being manually swingable downward from the closed position allowing access to the hollow interior of said core stick upper portion and thereafter back upward to a closed sealing position over said core stick upper portion.

12. In combination, a combination drink bottle and frozen comestible maker apparatus comprising:
a beverage compartment having an upper and an interior portion;
a hollow cylindrical core stick having an upper portion and a lower portion;
a cap member having an upper portion and a lower portion and a hole throughout the center for receiving said core stick;
a handle member having an upper portion and a lower portion and a hole comprised therein for receiving said core stick;
whereby said cap member lower portion can detachably engage with said beverage compartment upper portion;
whereby said cap member upper portion can detachably engage with said handle member lower portion;
whereby said core stick is positioned in said cap member so that when said cap member is engaged with said beverage compartment at least part of said lower portion of said core stick is housed within said interior portion of said beverage compartment; and
at least part of said upper portion of said core stick protrudes from said upper portion of said cap member;
wherein said beverage compartment upper portion comprises a threaded portion having external threads, and said cap member bottom portion comprises a threaded portion having internal threads, said external threads of said threaded portion of said beverage compartment threadedly engages said internal threads of said threaded portion of said cap member bottom portion; and
wherein said cap member upper portion comprises a threaded portion having external threads, and said handle member bottom portion comprises a threaded portion having internal threads, said external threads of said threaded portion of said cap member threadedly engages said internal threads of said threaded portion of said handle member bottom portion.
